(19) United States
(12) Patent Application Publication
(10) Pub. No.: US 2024/0065933 A1
(43) Pub. Date: Feb. 29, 2024

(54) MODULE FOR SNAP IN ATTACHMENT IN A COMPRESSION WRAP WITH THERMAL ELEMENT

(71) Applicant: Brownmed, Inc., Boston, MA (US)

(72) Inventors: Brandon Rodriguez, Westwood, MA (US); Courteney DiDomenico, Somerville, MA (US); Ivan E. Brown, Newton Highlands, MA (US)

(21) Appl. No.: 18/455,244

(22) Filed: Aug. 24, 2023

Related U.S. Application Data
(60) Provisional application No. 63/373,575, filed on Aug. 26, 2022.

(51) Int. Cl. A61H 23/02

(52) U.S. Cl. CPC A61H 23/0254; A61H 2201/02; A61H 2201/165; A61H 2201/5002; A61H 2201/5005; A61H 2201/503

(57) ABSTRACT

A therapeutic device includes flexible vibrating module with flexible radiating arms outwardly projecting around the module, with each arm having an associated coin motor which can optionally be operated at high frequency or low frequency or pulsing frequency. In addition to the vibratory elements of the device, a selective thermal element is included to provide heating and/or cooling for additional therapy. The heat, cooling, and/or vibrations can be used together or alone to provide therapeutic benefits to various body locations of a user. The device can be used with a wrap to hold the device in place for use.

### CROSS-REFERENCE TO RELATED APPLICATIONS

This application claims priority under 35 U.S.C. § 119 to provisional patent application U.S. Ser. No. 63/373,575, filed Aug. 26, 2022. The provisional patent application is herein incorporated by reference in its entirety, including without limitation, the specification, claims, and abstract, as well as any figures, tables, appendices, or drawings thereof.

### TECHNICAL FIELD

The present disclosure relates generally to therapeutic devices. More particularly, but not exclusively, the present disclosure relates to a module for use with a compression wrap that includes both vibration and thermal elements (heating and/or cooling) to provide therapeutic treatments to selected portions of a user's body.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Both vibration therapy and compression wraps for muscles and joints have been around for some time, and both have been used with some degree of therapeutic success. While there are available massaging devices for muscles and joints, their success, or lack of it, depend greatly upon their combined effectiveness. That is, both the effectiveness of the wrap and the effectiveness of the vibration and heat therapy. Each affects the other and collectively they affect the therapeutic success of the device/wrap in question.

With miniaturization of vibration inducing modules, the ability to be far more creative in developing vibration modules and wraps that affectively penetrate muscles and joints with vibrations and/or pulsations has increased tremendously. For examples of vibration wraps and or gloves, see the commonly owned and assigned U.S. Pat. No. 9,775,769, issued Oct. 3, 2017, which is incorporated herein in its entirety by this reference. The '769 patent relates particularly to an orthotic compression glove for massaging the fingers and digits. It uses coin motors with a rechargeable battery, with the unit embedded in a stretchable compression glove. For an example of a vibration knee wrap, one may look to U.S. Pat. No. 8,753,299 for massaging knees with a compression wrap that utilizes vibrating motors surrounding the kneecap.

Holding vibrating motors in a fixed location in a wrap regardless of the flexing of a joint to many different orientations offers some difficulty. That is to say, to enhance the vibration effectiveness, the coin motors need to be juxtaposed closely to the muscle or joint in a correct orientation.

For at least these reasons, some efforts have been made to produce vibration modules to flex with a moving joint, such as for an athlete. For example, see U.S. Pat. No. 10,159,623, issued Dec. 25, 2018. The '623 patent relates to a wearable vibration device that employs a soft wearable module to deliver high energy vibration deep in the muscle and soft tissue when placed inside a liner. It is lined up with holes of an alignment wrap and Velcro straps are then tensioned to hold the wearable module against the skin. The problem is such units do not hold firmly and alignment can be jostled out of place, particularly by vigorous athletic motion.

With the developing coin motor technology and compression wrap technology, there has been demonstration of a particular need for an improved flexible module or pad that will allow the pad to flexibly bend with the limb or joint to keep the vibrating motors tightly positioned against the wearer's skin, even in athletic movement.

Commonly owned and assigned U.S. Pat. No. 10,695,262, issued Jun. 30, 2020, and progeny, which are hereby incorporated by reference in its entirety, addresses at least some of the issues provide. The '262 patent includes a flexible vibrating module with flexible radiating arms outwardly projecting around the module, with each arm having an associated coin motor which can optionally be operated at high frequency or low frequency or pulsing frequency. This can be used with a wrap having a snap in flexible grommet for the module to consistently orient properly the module with respect to a patient's muscles or joints.

While the vibrating module provides some therapeutic relief, it has been shown that the addition of temperature controls provides even greater benefits. The use of heating or cooling with wraps for muscles could provide additional benefits.

Thus, there exists a need in the art for an apparatus which provides multiple therapeutic benefits to muscles and joints of users, which includes both vibratory and temperature therapies.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide therapeutic benefits to different body locations of a user. For example, the systems and apparatus provided can be used on a number of locations of a body to provide physical therapy thereto.

It is still yet a further object, feature, and/or advantage of the present disclosure to provide a plurality of therapy types for a user. This can be both in the form of vibratory therapy and temperature therapy, such as by providing heating or cooling therapy to a user's body location.

The apparatus and/or systems disclosed herein can be used in a wide variety of applications. For example, physical therapists could use the apparatus to provide treatment. In addition, the apparatus can be used on an as-need basis by a user at their location, such as at home for therapy.

It is preferred the apparatus be safe, cost effective, and durable. For example, the apparatus can be adapted to resist excessive heat, static buildup, corrosion, and/or mechanical failures (e.g., cracking, crumbling, shearing, creeping) due to excessive impacts and/or prolonged exposure to tensile and/or compressive forces acting on the apparatus.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the apparatus.

Methods can be practiced which facilitate use, manufacture, assembly, maintenance, and repair of an apparatus which accomplish some or all of the previously stated objectives.

According to at least one aspect, a therapeutic hub comprises a housing comprising a plurality of flexible arms radially extending from the housing; a plurality of vibratory motors, each of which being associated with one of the plurality of flexible arms; a thermal element positioned in the housing; and a control system for selectively operating the vibratory motors and the thermal element, said control system comprising: a control circuit and a battery electrically connected to the plurality of vibratory motors and the thermal element; wherein the control circuit allows for the selective operation of one or both of the vibratory motors and the thermal element.

According to some aspects of some embodiments, the control system further comprises a power button.

According to some aspects of some embodiments, the control system further comprises a user interface to provide controls for operating the control system.

According to some aspects of some embodiments, the user interface comprises a plurality of control buttons to operate the control system.

According to some aspects of some embodiments, the battery comprises a lithium-ion battery.

According to some aspects of some embodiments, the housing comprises silicone.

According to some aspects of some embodiments, the housing comprises an upper cover and a lower cover connected to one another.

According to some aspects of some embodiments, the vibratory motors comprise coin motors.

According to some aspects of some embodiments, the control circuit operates the plurality of vibratory motors in one of a high frequency vibration setting, a low vibration frequency setting, and a pulsing setting.

According to some aspects of some embodiments, a remotely operated app, such as on a phone, tablet, or other handheld, could include a user interface to operate the therapeutic hub.

According to some aspects of some embodiments, the remote app is connected to the therapeutic hub wirelessly, such as via Bluetooth.

According to additional embodiments, a therapeutic hub comprises a silicone housing comprising an upper portion and a lower portion and a plurality of flexible arms radially extending from the housing; and a therapeutic system housed at least partially in the silicone housing, said therapeutic system comprising: a user interface; a control circuit and battery connected to the user interface; a plurality of vibratory motors, each of said plurality of vibratory motors associated with one of the plurality of flexible arms; and a thermal element extending at least partially into each of the plurality of flexible arms.

According to some aspects of some embodiments, the user interface comprises a power button. The user interface can be located on the therapeutic hub or can be a remote app on a phone, tablet, handheld, smart device, computer, or other device with wireless connectivity and an interface.

According to some aspects of some embodiments, the user interface further comprises one or more control buttons to adjust the vibratory motors and/or the thermal element.

According to some aspects of some embodiments, the vibratory motors comprise coin motors.

According to some aspects of some embodiments, the control circuit operates the plurality of vibratory motors in one of a high frequency vibration setting, a low vibration frequency setting, and a pulsing setting.

According to some aspects of some embodiments, the thermal element is electrically activated and controlled via the control circuit.

According to some aspects of some embodiments, the battery comprises a lithium-ion battery that is rechargeable.

According to yet additional embodiments, a therapeutic hub having a plurality of flexible arms extending from a central region comprises a plurality of vibratory motors, with one of the vibratory motors in each of the plurality of flexible arms; a thermal element extending at least partially into each of the plurality of flexible arms to provide heating or cooling thereto; and a control circuit to selectively activate the plurality of vibratory motors and the thermal element to allow selective therapeutic treatment at the plurality of flexible arms.

According to some aspects of some embodiments, the hub further comprises a user interface operatively connected to the control circuit to control the selective therapeutic treatment. The user interface can be located on the therapeutic hub or can be a remote app on a phone, tablet, handheld, smart device, computer, or other device with wireless connectivity and an interface.

According to some aspects of some embodiments, the hub further comprises a housing for enclosing the plurality of vibratory motors, the thermal element, and the control circuit, said housing comprising a silicone material.

According to some aspects of some embodiments, the hub further comprises a battery connected to the plurality of vibratory motors, the thermal element, and the control circuit to provide electric power thereto.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a perspective view of a therapeutic hub according to aspects and/or embodiments disclosed herein.

FIG. 2 is a top plan view of the therapeutic hub of FIG. 1.

FIG. 3 is a front elevation view of the therapeutic hub of FIG. 1.

FIG. 4 is a side elevation view of the therapeutic hub of FIG. 1.

FIG. 5 is a bottom plan view of the therapeutic hub of FIG. 1.

FIG. 6 is an exploded view of the therapeutic hub of FIG. 1.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

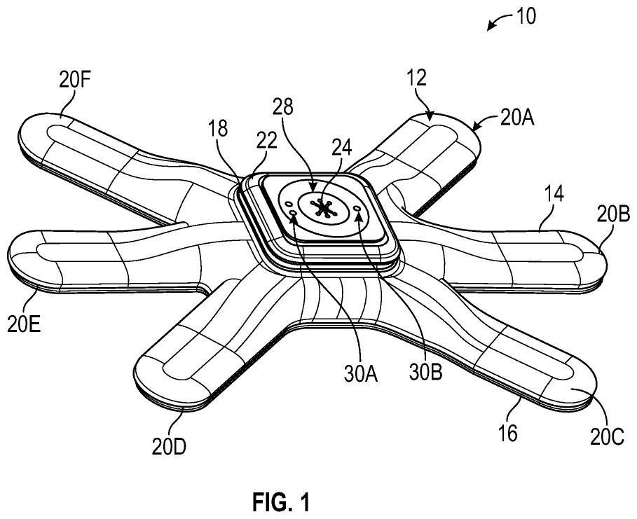

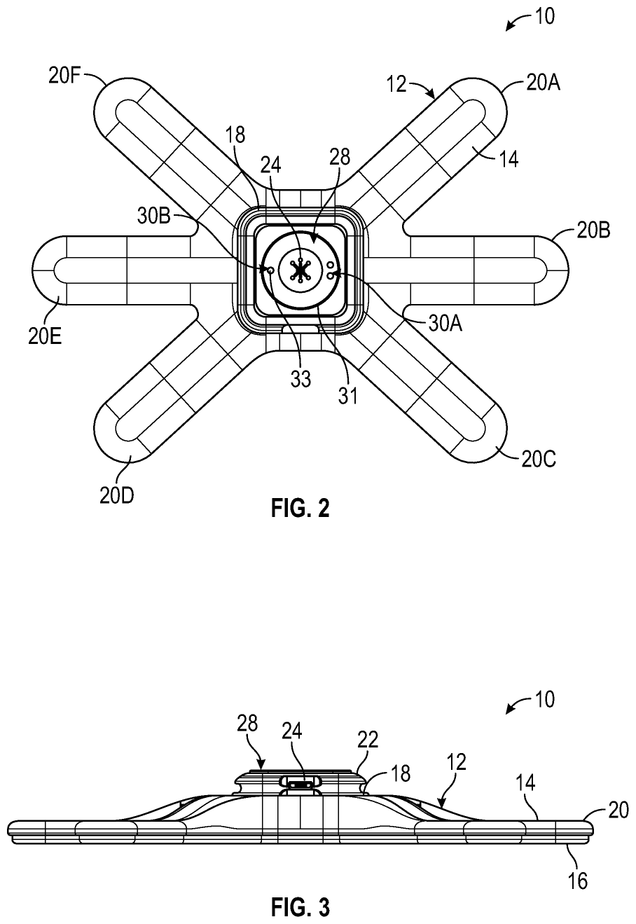

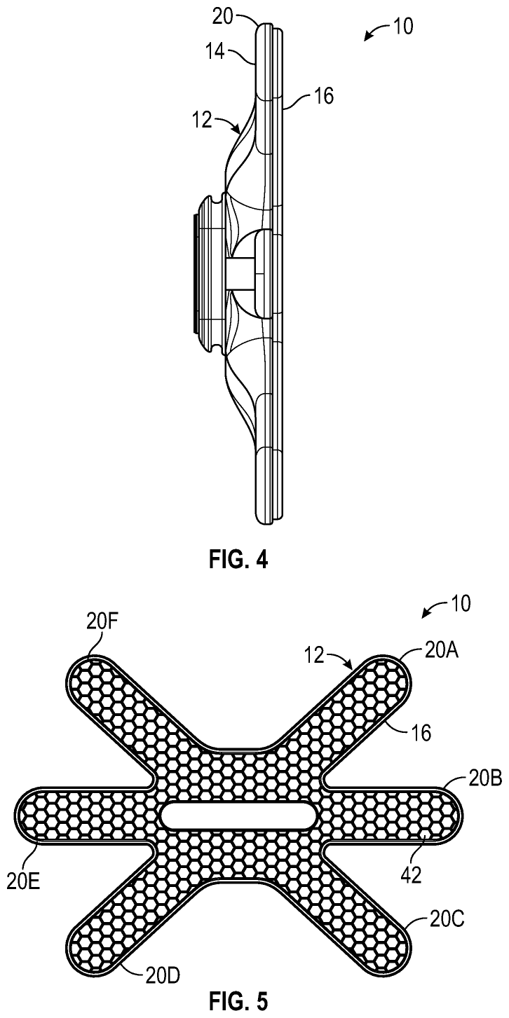

Referring now to FIGS. 1-5, a therapeutic hub device 10 is shown. The therapeutic hub 10 is similar to that shown and described in U.S. Pat. No. 10,695,262, issued Jun. 30, 2020, which is hereby incorporated by reference in its entirety. However, as will be understood, there are improvements and changes in the device 10 shown and described according to the various aspects and/or embodiments disclosed herein.

The therapeutic device 10 includes a housing 12. According to at least some aspects of some embodiments, the housing 12 comprises a flexible material, which may be a polymeric material such as a silicone polymer. However, as will be understood, other materials that can promulgate vibrations and heat and/or cooling may be utilized for the housing, including, but not limited to, thermoplastic elastomeric materials (TPEs) or the like. Still further, according to at least some embodiments, the housing 12 comprises multiple sections, such as an upper section 14 and a lower section 16, which are connected to another via a seam. The separate sections allow components to be positioned at least partially within the housing and allows easier access to the interior of the housing.

As shown best in FIG. 5, the bottom of the bottom section 16 of the housing 12 may include a honeycomb pattern 42, at least in some embodiments. The honeycomb pattern 42 includes a number of honeycombs which may provide a better surface engagement, such as with a portion of the user's body, and which mitigates slipping between the hub housing and the user. The honeycombs may also better promulgate the vibration, cooling, and/or heat from the hub 10. However, the honeycombs are not needed in all embodiments, and other shapes or no shapes may be included.

The construction of the top cover 14 can utilize an overmolding process to join the flexible silicone cover to a rigid internal frame (not shown). The internal frame mitigates migration or damage of the internally housed central electronics while also adding durability. The use of over molding allows one to seamlessly integrate a rigid material into the pad design while still offering a comfortable and flexible one-piece top cover.

Positioned generally at or near an axial location of the housing 12 on an upper portion thereof (such as upper portion 14 when multiple sections are included) is a grommet portion 18. As will be understood, the grommet 18 is positioned to locate portions of the hub 10, such as portions of a user interface 28 for operating the hub 10.

Extending radially outward from the axial location around the grommet 18 are a plurality of flexible arms, which are shown to include first arm 20A, second arm 20B, third arm 20C, fourth arm 20D, fifth arm 20E, and sixth arm 20F. While six arms 20 are shown, it should be appreciated that this is not to be limiting on the invention, and the number of arms may vary depending on size and intended use. For example, there may be more or less than six arms. The arms are flexible and may comprise a similar material as the rest of the body. This may be silicone or a silicone polymer. The material is chosen to promulgate vibration in the arms, as well as cooling or heat, when selected. The arms 20 are shown to have a length and width, which are not to be limiting. For example, the length and/or width could vary according to body part for use with the device 10, or for different ages and/or sizes of users.

The arms 20 extend from the hub 10 to form a starfish, octopus, or similarly patterned shape. As will be understood, the arms 20 are narrower than having the hub 10 comprises a circular or other “blob-like” shape. This allows the thermal elements and vibrations to require less power needed to provide the therapeutic benefits at the arms thereof.

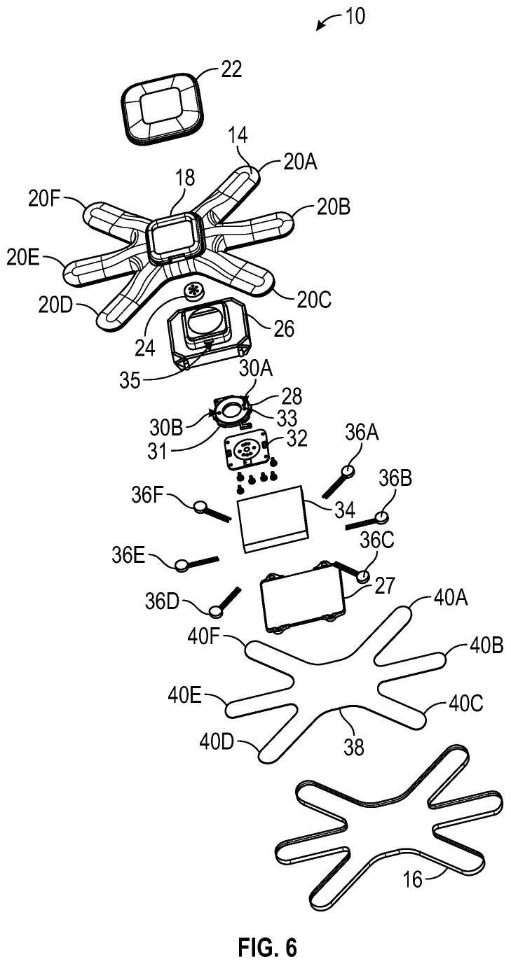

The therapeutic device 10 is configured to provide both vibration and temperature control (heat or cooling) for a user, which provides therapeutic benefits. In order to control the device, a number of internal or substantially internal components are provided, and are best shown in FIG. 6, which is an exploded view of one embodiment of a therapeutic device 10 according to aspects of the present disclosure.

As shown in FIG. 6, a cover plate 22 is generally external of the housing 12 and interacts with a casing 26 that is at least partially inside or enclosed in the housing 12. The cover plate 22 helps to protect aspects of the device 10. Positioned generally within the casing 26, 27 are a user interface 28 comprising a power button 24 (otherwise referred to as an on/off switch) and other control buttons 30 (such as shown the ring 31), a printed circuit board/controller 32 (also referred to as a PCB), and a battery 34.

A user interface is how the user interacts with a machine. According to at least some aspects of some embodiments disclosed, the user interface 28 of the hub 10 may be in the form of the power button 24 and control buttons 30A, 30B. The power button 24 may turn the hub on/off, while the control buttons 30A, 30B toggle the hub between various settings. As will be understood, the hub 10 can promulgate either or both of vibrations and thermal controls. The control buttons 30 can toggle the hub 10 between settings to put the hub in the desired setting for promulgation. For example, the control button 30A controls the vibrations to one of a high frequency vibration setting, a low vibration frequency setting, and a pulsing setting. In addition, the thermal settings could have multiple possible outputs to vary the amount of heating and/or cooling promulgated by the hub 10, such as via the control button 30B. Output lights 33 could be included at or near the ring 31 to provide feedback and status as to which setting is currently selected for output of the therapeutic hub 10. The lights could be chosen by color to indicate thermal setting, as well as which of the vibration settings are operating. Still other alerts could be provided, such as sound or the like. In addition, audio feedback could be used to alert a user to the selected setting. The status lights 33 could also be used to alert a user know that the battery needs recharged, or other alerts. The status lights 33 may be light emitting diodes (LEDs). Still further, haptic feedback can be provided to alert the user as to the status or setting of the device. For example, different haptic feedbacks (e.g., different lengths of vibrations or number of vibrations) could be provided to let a user know as to the vibration setting and/or the thermal setting. The vibration style could let the user know if a thermal setting (heating or cooling) has been activated. This is useful in locations where the hub is applying a therapeutic treatment to a body part that is difficult to see by the user (e.g., on a user's back).

To operate the unit, one simply turns on the on/off switch 14 by pressing it, and then selects from the mode by how many pushes of one or both of the control buttons 30A, 30B, which is indicated by the LEDs 33.

With respect to batteries, the battery may be rechargeable, such as a lead-acid battery, a low self-discharge nickel metal hydride battery (“LSD-NiMH”) battery, a nickel-cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable. However, it should also be contemplated that another power supply be utilized, such that the power supply outputs a particular voltage to a device or component or components of a device. The power supply could be a direct current (“DC”) power supply (e.g., a battery), an alternating current (“AC”) power supply, a linear regulator, etc.

According to at least some aspects of some embodiments, the battery is a 1.5V C battery that has a high discharge rate. The battery could also have safety features built in, such as current control for when the battery is charging. The battery 34 can be recharged via charging cord or pad. For example, a port 35 can connect to a charging cable, such as a Micro-USB-B style connection to provide a charge to the battery. However, other types of charging ports and/or types may be used. In addition, wireless charging could be used, such as radio charging, inductive or near field charging, or resonance charging.

The PCB 32 is a laminated sandwich structure of conductive and insulating layers. PCBs have two complementary functions. The first is to affix electronic components in designated locations on the outer layers by means of soldering. The second is to provide reliable electrical connections (and also reliable open circuits) between the component's terminals in a controlled manner often referred to as PCB design. Each of the conductive layers is designed with an artwork pattern of conductors (similar to wires on a flat surface) that provides electrical connections on that conductive layer. Another manufacturing process adds vias, plated-through holes that allow interconnections between layers.

PCBs mechanically support electronic components using conductive pads in the shape designed to accept the component's terminals, and also electrically connect them using traces, planes and other features etched from one or more sheet layers of copper laminated onto and/or between sheet layers of a non-conductive substrate. Components are generally soldered onto the PCB to both electrically connect and mechanically fasten them to it. Semiconductors, connectors, resistors, diodes, capacitors, and radio devices are mounted to, and “talk” to one another through the PCB. Thus, as will be understood, the PCT 32 provides a nexus between the user interface components and the vibratory motors and thermal element of the therapeutic device.

As noted, electrically coupled to the PCB 32 are a plurality of vibratory motors 36. The number of motors will generally correspond with the number of arms 20, and thus, FIG. 6 shows a first motor 36A, second motor 36B, third motor 36C, fourth motor 36D, fifth motor 36E, and sixth motor 36F. According to at least some embodiments, the motors are coin motors. Vibrating coin motors are known and are available from a variety of sources. One example suitable for use herein are those described in our earlier U.S. Pat. No. 9,775,769A suitable supplier of those is Shenzhen Jingkefa Electronics Company Limited a battery suitable for the vibrating motors is lithium-ion batteries such as a 3.7-volt lithium-ion battery. Frequencies suitable for the vibration therapy are known and generally have been described as within the range of 20-50 Hz.

Still further, as shown best in FIG. 6, a thermal element 38 is shown within the housing 12 of the hub device 10. The thermal element 38 provides heat and/or cooling to be transferred from the element 38 to the user through the housing 12, which will increase the therapeutic benefits from using the device 10. The combination of vibration and heat and/or cooling have been shown to be effective for treatments of body parts, and thus, this combination by the device 10 will be an improvement over prior devices.

According to some aspects of some embodiments, the thermal element is a thermal heating element 38 that is an electronic heating element and can be electrically connected to the battery 34. The heating element 38 is shaped generally to match the shape of the housing 12, including a number of radially extending arms. This includes, first arm 40A, second arm 40B, third arm 40C, fourth arm 40D, fifth arm 40E, and sixth arm 40F. The number of arms generally matches the number and configuration of the arms 20 of the housing, so as to provide heat to the arms. Thus, the number can be varied.

According to at least some aspects of some embodiments, the thermal heating element 38 comprises a substrate with a metallic conductor thereon. The electrical connection between the battery 34 and the conductor of the heating element will provide the resistance to heat up the conductor, thus creating the heat for the device. The conductor may be a relatively thin layer on the substrate to allow for flexibility of the device, along with the vibration moving the elements of the device. The conductor may be metallic, such as titanium or the like, which provides rapid heating to the heating element, which can then be transferred through the arms 20 of the housing and to the user. The use of the metallic conductor and silicone is also such that the device 10 will not retain heat and will be able to be handled with mitigating injury due to contact with the heating element 38.

According to additional aspects, the thermal element 38 is a heating pad in the form of a graphite thermal pad, which comprises printed graphite on a circuit board. Such a board has a high efficiency and provides internal thermal conduction for the hub 10. In addition, the heating pad will substantially match the shape of the arms. In such a starfish shape, the arms are narrower, which require less power to provide the heat thereto.

As further noted, the thermal element 38 could be a cooling element or could be both a heating and cooling element. To provide cooling, the element 38 could provide electric cooling, such as with a Peltier cooling pad. Other types of cooling could be provided, either electrically or otherwise. For example, a separate wrap could be provided that includes an outline that matches or substantially matches the shape of the arms 20. The outline can include a phase change media (PCM) that can be cooled, such as in a refrigerator or freezer. The PCM can be the cooling element that is used to provide the cooling or could be used in combination with a heating element. The cold on the periphery of the arms would reduce inflammation that can occur due to the precise heating of the thermal element of the hub. Thus, the heat and cooling could be used together to provide additional benefits.

The cooling element could also be a separate gel pad or other insertable member that is cooled in a cool environment and then added for use with a hub via a wrap or otherwise. This could be as simple as placing a cooling pad under a portion of the hub and/or wrap, or including a cooling pad in a specialized pouch.

For any type of thermal element used, the hub 10 can include a built-in thermostat to aid in controlling the temperature output of the element 38. The hub 10 could also include a built-in timer to provide preset therapies based on time, thermal setting, and/or vibration pattern.

As has been included, the user interface 28 could be located on a remote device that is coupled to the hub 10. Such remote devices could be any device including a processing unit and communication apparatus. Processing units are common in tablets, telephones, handheld devices, laptops, user displays, smart devices (TV, speaker, watch, etc.), and other computing devices. The device and hub could be connected to a network for communicating with one another to provide one or more inputs from the device to the hub via the network. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein.

With a remote device connected to a hub, the remote device could include a digital or graphical interface. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

The remote app can provide at least the same number of inputs for the hub, and can also include more, such as by providing greater control for any of the features of the hub 10. For example, the app can include near infinite adjustability of the vibration levels/patterns, thermal settings, timers, etc. For vibration, this could be a single level setting or a recurring pattern that is set by a user. For thermal control, a user could provide a thermal level (either hot or cold), such as by sliding a selector bar, inputting a value (i.e., degrees F. or C), or selection from a number of present values. The time could be set to operate for a selected amount of time, which will operate the hub for said amount of time. The options are near limitless for control, including the on/off functionality of the hub. Thus, the connection between a device with an app and the hub will allow a user to customize and operate the hub in a number of additional manners. The app can be operated on any number of operating systems on the devices, and the language, operating system, and the like for the app is not to be limiting to the present disclosure.

Still further, while the device 10 is shown and described, it should be appreciated that the hub 10 be in the form of a module that is connectable to various wraps, such as is shown and described in the incorporated '262 patent. For example, the hub 10 may be used with a variety of differing wraps, many referred to as compression wraps. It can be used in combination for example with a knee wrap, an elbow wrap, a calf or shin wrap, an ankle or foot wrap, upper thigh wraps, lower back wraps, wrist wraps, gloves, and shoulder wraps. Still further, the wrap could be a “universal wrap” that could be used generally with any portion of the body by the user and moved around as well. Universal Therapy Wrap delivers targeted vibration and/or thermal therapy that aids in pain relief and recovery for shoulders, back, arms, knee, calf, foot, ankle and more.

The device, with or without a wrap, can be positioned at or against a portion of the user's body, and operated to provide therapeutic treatment in the form of heating, cooling, and/or vibration, which can provide physical benefits, such as muscle treatment and relief.

As disclosed in the '262 patent, the cover plate 22 could be inserted into a portion of a wrap, such as a grommet, for use therewith. The wrap could include a gel outlined portion that coincides with the outer periphery of the arms 20 of the hub 10. The wrap with gel could be cooled in an environment, such as a freezer or other cold environment, to cool the gel or other material therein. The thermal heating element can provide the direct application of heat to a user's location, while the cold gel could isolate the heat and mitigate inflammation caused by the heated element.

According to some embodiments, the wrap comprises a neoprene or like material that aids in retaining heat of the user therein. The neoprene provides compression for the user at the location of use for the hub and also aids in controlling the thermal aspects (both hot and cold) of the system. Neoprene is beneficial as it has a high heat resistance, while also having high flexibility.

From the foregoing, it can be seen that the present disclosure accomplishes at least all of the stated objectives.

1. A therapeutic hub, comprising:
a housing comprising a plurality of flexible arms radially extending from the housing;
a plurality of vibratory motors, each of which being associated with one of the plurality of flexible arms;
a thermal element positioned in the housing; and
a control system for selectively operating the vibratory motors and the thermal element, said control system comprising:
a control circuit and a battery electrically connected to the plurality of vibratory motors and the thermal element;
wherein the control circuit allows for the selective operation of one or both of the vibratory motors and the thermal element.

2. The therapeutic hub of claim 1, wherein the control system further comprises a power button.

3. The therapeutic hub of claim 2, wherein the control system further comprises a user interface to provide controls for operating the control system.

4. The therapeutic hub of claim 3, wherein the user interface comprises a plurality of control buttons to operate the control system.

5. The therapeutic hub of claim 1, wherein the battery comprises a lithium-ion battery.

6. The therapeutic hub of claim 1, wherein the housing comprises silicone.

7. The therapeutic hub of claim 6, wherein the housing comprises an upper cover and a lower cover connected to one another.

8. The therapeutic hub of claim 1, wherein the vibratory motors comprise coin motors.

9. The therapeutic hub of claim 1, wherein the control circuit operates the plurality of vibratory motors in one of a high frequency vibration setting, a low vibration frequency setting, and a pulsing setting.

10. A therapeutic hub, comprising:
a silicone housing comprising an upper portion and a lower portion and a plurality of flexible arms radially extending from the housing; and
a therapeutic system housed at least partially in the silicone housing, said therapeutic system comprising:
a user interface;
a control circuit and battery connected to the user interface;
a plurality of vibratory motors, each of said plurality of vibratory motors associated with one of the plurality of flexible arms; and
a thermal element extending at least partially into each of the plurality of flexible arms.

11. The therapeutic hub of claim 10, wherein the user interface comprises a power button.

12. The therapeutic hub of claim 11, wherein the user interface further comprises one or more control buttons to adjust the vibratory motors and/or the thermal element.

13. The therapeutic hub of claim 10, wherein the vibratory motors comprise coin motors.

14. The therapeutic hub of claim 13, wherein the control circuit operates the plurality of vibratory motors in one of a high frequency vibration setting, a low vibration frequency setting, and a pulsing setting.

15. The therapeutic hub of claim 10, wherein the thermal element is electrically activated and controlled via the control circuit.

16. The therapeutic hub of claim 11, wherein the battery comprises a lithium-ion battery that is rechargeable.

17. A therapeutic hub having a plurality of flexible arms extending from a central region, the hub comprising:
a plurality of vibratory motors, with one of the vibratory motors in each of the plurality of flexible arms;
a thermal element extending at least partially into each of the plurality of flexible arms to provide heat thereto; and
a control circuit to selectively activate the plurality of vibratory motors and the thermal element to allow selective therapeutic treatment at the plurality of flexible arms.

18. The therapeutic hub of claim 17, further comprising a user interface operatively connected to the control circuit to control the selective therapeutic treatment.

19. The therapeutic hub of claim 17, further comprising a housing for enclosing the plurality of vibratory motors, the thermal element, and the control circuit, said housing comprising a silicone material.

20. The therapeutic hub of claim 17, further comprising a battery connected to the plurality of vibratory motors, the thermal element, and the control circuit to provide electric power thereto.
